(19) United States
(12) Patent Application Publication
(10) Pub. No.: US 2018/0238109 A1
(43) Pub. Date: Aug. 23, 2018

(54) Chain or Cord Cover for Window Treatments

(71) Applicant: Sun Glow Window Covering Products of Canada Ltd., Toronto (CA)

(72) Inventors: Vivian KANARGELIDIS, Toronto (CA); Catalin Aurel MOCANU, Mississauga (CA)

(21) Appl. No.: 15/480,901

(22) Filed: Apr. 6, 2017

Related U.S. Application Data
(60) Provisional application No. 62/462,218, filed on Feb. 22, 2017.

(51) Int. Cl. E06B 9/42; E06B 9/78

(52) U.S. Cl. CPC E06B 9/42; E06B 9/78

(57) ABSTRACT

A cover for a chain or cord is provided, that is used to manually operate a window treatment. The cover includes a plurality of chain guide segments, each segment comprising a pair of rigid tubular members to permit passage of the chain or cord therethrough during operation of the window treatment. A total length of the plurality of segments is less than each vertical run of the chain or cord to permit separation of adjacent ones of the segments to expose a portion of the chain or cord to manually operate the window treatment. A chain separator to be coupled to a lowermost one of the segments is also provided.

### CROSS-REFERENCE TO RELATED APPLICATION(S)

This application claims priority to U.S. Provisional Patent Application No. 62/462,218 filed on Feb. 22, 2017, the contents of which are incorporated herein by reference.

### TECHNICAL FIELD

The following relates to chain or cord covers for window treatments such as roller shades.

### DESCRIPTION OF THE RELATED ART

Some window treatments such as roller shades are known to be operated by a hanging chain or cord, wherein pulling the chain or cord in one direction moves the window treatment in one direction (e.g., down), while pulling the chain or cord in the other direction moves the window treatment in the opposite direction (e.g., up). These chains and cords are often relatively long to allow users of different heights to operate the window treatment.

While a relatively long chain or cord is convenient to the user, they have been found to pose potential choking hazards for young children and infants. To address this issue, one option is to have a chainless window treatment, however, such solutions are typically more expensive than traditional window treatments operated manually by chains or cords, and require a motor and batteries, or a connection to a power source such as a wall outlet. Moreover, there are many existing window treatments that would need to be replaced in order to address this issue, which can be prohibitive and costly.

It is an object of the following to address the above disadvantages.

### SUMMARY

A cover is provided to contain, conceal, and impede the formation of relatively large loops in a chain or cord for a manually operated window treatment, to minimize the amount of chain or cord that is exposed both during operation and when not being operated. The cover can be added to new and existing window treatment chains and cords, thus allowing older models to be retrofitted.

In one aspect, there is provided a cover for a chain or cord used to manually operate a window treatment, the cover comprising at least one pair of rigid tubular members to permit passage of the chain or cord therethrough during operation of the window treatment.

In another aspect, there is provided a cover for a chain or cord used to manually operate a window treatment, the cover comprising a plurality of chain guide segments, each segment comprising a pair of rigid tubular members to permit passage of the chain or cord therethrough during operation of the window treatment, wherein a total length of the plurality of segments is less than each vertical run of the chain or cord to permit separation of adjacent ones of the segments to expose a portion of the chain or cord to manually operate the window treatment.

In yet another aspect, there is provided a window treatment comprising: a panel for covering at least a portion of a window; a lifting/lowering mechanism connected to the panel; a chain or cord for manually operating the lifting/lowering mechanism; and a cover for the chain or cord, the cover comprising a plurality of chain guide segments, each segment comprising a pair of rigid tubular members to permit passage of the chain or cord therethrough during operation of the window treatment, wherein a total length of the plurality of segments is less than each vertical run of the chain or cord to permit separation of adjacent ones of the segments to expose a portion of the chain or cord to manually operate the window treatment.

### BRIEF DESCRIPTION OF THE DRAWINGS

Embodiments will now be described by way of example only with reference to the appended drawings wherein:

FIG. 1 is a perspective view of a manually operated window treatment with a chain cover for concealing the chain used to operate the window treatment;

FIG. 2 is a perspective view of a double chain guide segment;

FIG. 3 is an end view of the double chain guide segment of FIG. 2;

FIG. 4 is a perspective view of a single chain guide segment;

FIG. 5 is an end view of the single chain guide segment of FIG. 4;

FIG. 6 is a perspective view of a pair of single chain guide segments coupled to each other;

FIG. 7 is an end view of the pair of single chain guide segments of FIG. 6;

FIG. 8A is a plan view of a chain diverter portion;

FIG. 8B is an elevation view of the chain diverter portion shown in FIG. 4A;

FIG. 8C is a perspective view of the chain diverter portion shown in FIG. 4A;

FIG. 9A is a plan view of a first chain diverter portion having slots and teeth;

FIG. 9B is a plan view of a second chain diverter portion having slots and teeth;

FIG. 9C is an elevation view of the chain diverter portions shown in FIGS. 9A and 9B;

FIG. 9D is a plan view of the first and second chain diverter portions during assembly thereof using the slots and teeth;

FIG. 9E is a perspective view of a the first and second chain diverter portions when coupled to each other;

FIG. 10 is a perspective view of a clutch for a lifting/lowering mechanism, showing a chain connector and a chain stop bead;

FIG. 11A is a perspective view of an assembled chain cover when not in operation;

FIG. 11B is a perspective view similar to FIG. 11A when the chain cover is in use, showing a separation between adjacent chain guide segments;

FIG. 11C is a perspective view similar to FIG. 11A with upper and lower chain diverters;

FIG. 12A is a side view of a manually operated window treatment with a chain cover for concealing the chain used to operate the window treatment, in a rest position;

FIG. 12B is a side view of a manually operated window treatment with a chain cover for concealing the chain used to operate the window treatment, during operation in one direction;

FIG. 12C is a side view of a manually operated window treatment with a chain cover for concealing the chain used to operate the window treatment, during operation in the opposite direction;

FIG. 13A is a side view of a manually operated window treatment with a chain cover without connecting portions between the tubular members;

FIG. 13B is a side view of a manually operated window treatment with a chain cover without connecting portions between some but not all of the tubular members; and

FIG. 13C is a side view of a manually operated window treatment with a chain cover with alternatively shaped connecting portions between the tubular members.

### DETAILED DESCRIPTION

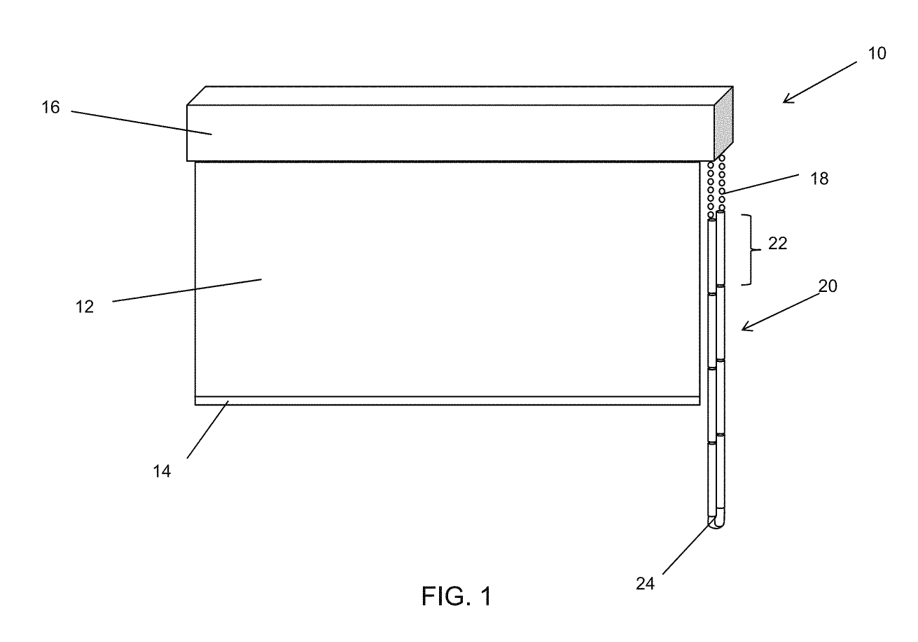

Turning now to the figures, FIG. 1 illustrates a perspective view of a window treatment, in this example a roller shade 10. The roller shade 10 includes a window-covering panel 12 having a weighting bar 14 at one end, and is connected at its opposite end to a lifting/lowering mechanism 16 such that it can be “rolled” up and into the lifting/lowering mechanism 16. Certain details of the lifting/lowering mechanism 16 have been omitted herein for the sake of brevity, and it will be appreciated that various types of lifting/lowering mechanisms 16 can be used within the scope of the principles described herein.

The lifting/lowering mechanism 16 is manually operated using a chain, cord, cable or other continuous elongated loop, hereinafter commonly referred to as a “chain 18” or interchangeably referred to as a chain or cord. To address the above-mentioned issues, the chain 18 is substantially contained, concealed, and operable within a cover 20. The cover 20 includes one or more chain guide segments 22 that are substantially rigid. By providing rigidity in the segments 22, and having a suitable number of segments 22 along the vertical runs of the chain 18, the choking hazards that may be associated with loops of chains and cords used to operate window treatments can be inhibited, by preventing the formation of such loops. To facilitate free movement of the chain 18 within the cover 20, a circular chain diverter 24 is attached at the bottom return loop of the chain 18 at the lower portion of the cover 20.

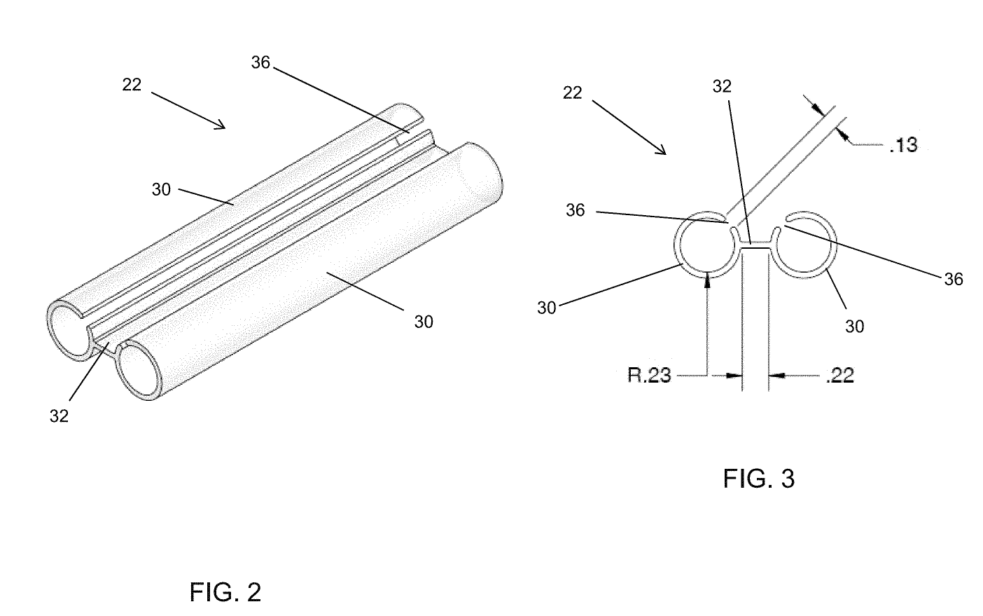

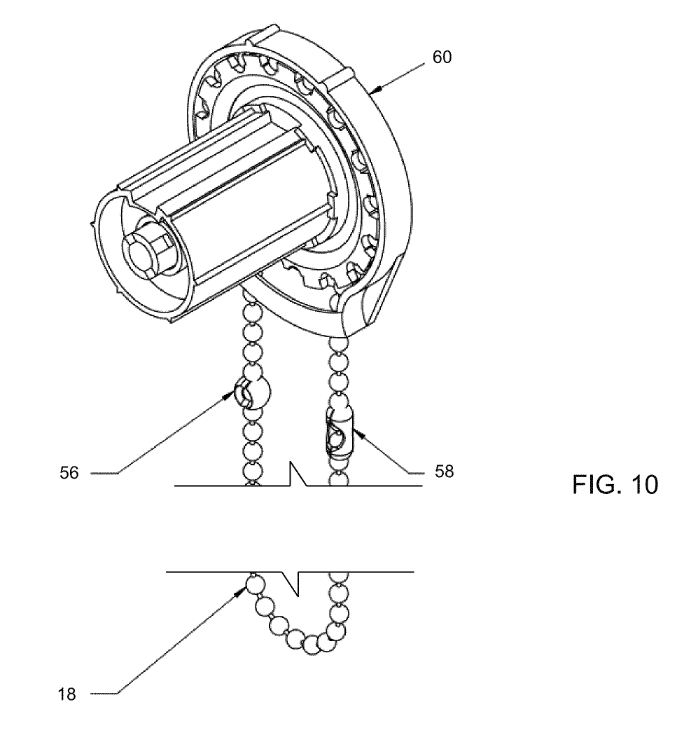

An enlarged perspective view of a segment 22 of the cover 20 is shown in FIG. 2, and an end view is shown in FIG. 3. The segment 22 of the cover 20 in this example can be considered a “double segment” that includes a pair of tubular members 30 connected to each other by a central connecting portion 32. The tubular members 30 are sized to allow passage of the chain 18, chain connector 58, and stop beads 56 therethrough (see also FIG. 10). The chains 18 can be premade loops, or are often made into loops by a connecting device (e.g., chain connector 58) that connects the ends of the chain 18 together. The tubular members 30 should therefore be sized to accommodate the chain connectors 58, and any stop beads 56 that are used to limit the extent to which the chain 18 moves through the clutch 60 (see again FIG. 10). The connecting portion 32 is sized to provide a particular separation between the vertical runs of the chain 18. It can be appreciated that such separation will vary based on the style and size of the window treatment with which the cover 20 is being used. The tubular members 30 are preferably made from a plastic material such as PVC to provide enough flexibility to allow the chain 18 to be inserted into its interior via a lengthwise slit 36. The tubular members 30 can be made of a clear or translucent plastic, or can be given a solid colour or have a patterned appearance. It can be appreciated that the use of a lightweight plastic material can be advantageous when compared to heavier metals and the like for applications where safety can be an issue, such as in prisons, childcare facilities, mental health facilities, etc.

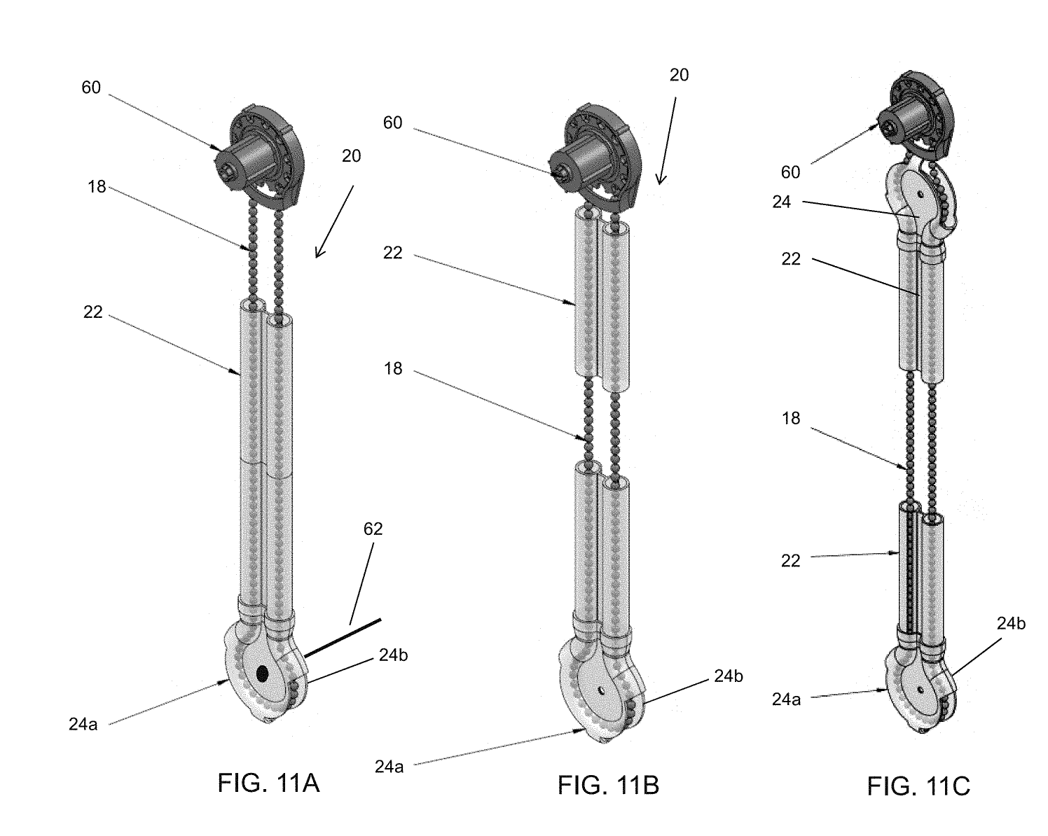

As best seen in FIG. 3, the slits 36 of a pair of tubular members 30 are preferably directed inwardly and positioned on the same side of the segment 22, so as to conceal the slits 36 from the side view of the roller shade 10 (see for example FIG. 11 discussed below). It can be appreciated that the segment 22 can also be made from other materials, and plastic is only one example. For example, a lightweight metal or composite material could also be used. Moreover, the slits 36 are an optional feature that allows the cover 20 to be retrofitted to an existing chain 18 in a faster and more convenient manner. However, for example, the chain 18 could instead be fed through a pair of the tubular members 30 prior to be joined endwise with a chain connector, and installed in the roller shade 10. To feed the chain 18 through the slit 36, the opposing edges that form the slit 36 are inserted between a pair of adjacent beads on the chain 18 and those edges slid along the chain 18 until the chain 18 has been fed into the segment 22.

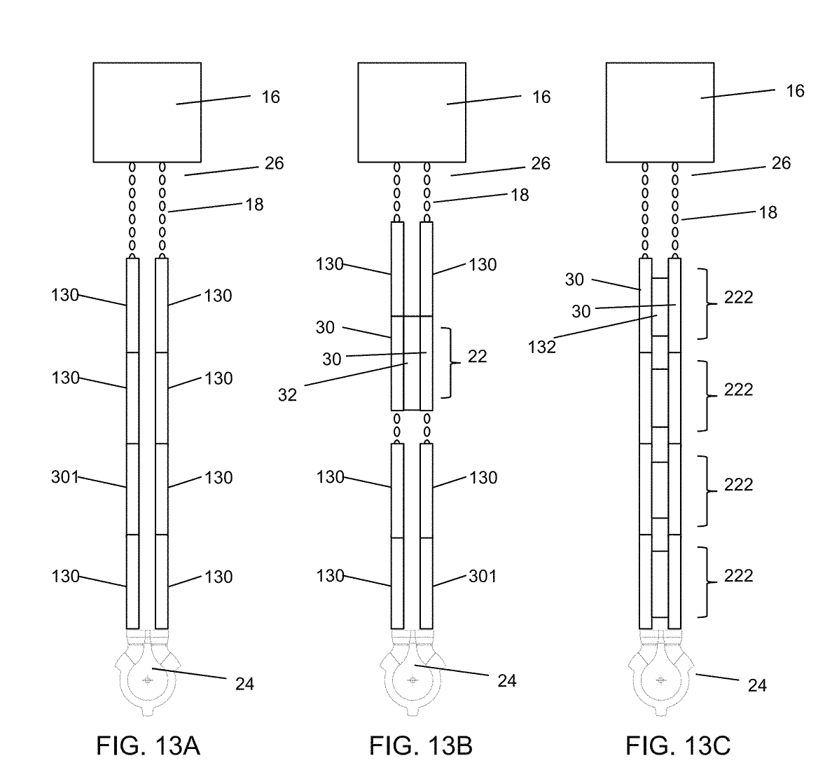

Some example dimensions are shown in FIG. 3 for illustrative purposes only, e.g. a 0.13 inch wide slit 36, and a 0.22 inch wide connecting portion 32. It can be appreciated that other dimensions, shapes, and configurations for the segments 22 are possible, for example using other tubular shapes such as oval, square, etc. Also, as discussed below, while the connecting portion 32 extends along the entire length of the tubular members 30 in the example shown in FIG. 2, the connecting portion 32 can extend along a shorter extent (see e.g., FIG. 13C).

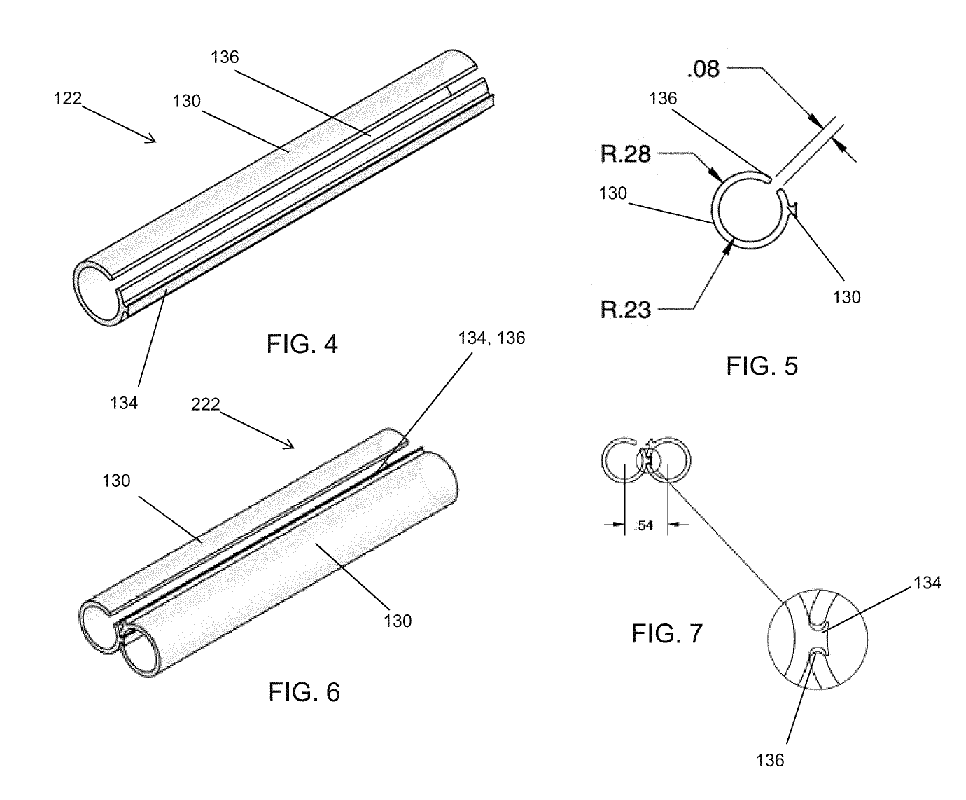

While the segments 22 shown in FIGS. 2 and 3 include a pair of tubular members 30 rigidly connected to each other, it can be appreciated that single tubular members 130 can also be used, as shown in FIGS. 4 and 5. The segment 122 shown in FIGS. 4 and 5 includes a tubular member 130 that includes a lengthwise slit 136, similar to the double segments 22 thus enabling the chain 18 to be slid through the slit 136 in a similar way, namely by inserting the edges forming the slit 136 between a pair of adjacent beads in the chain 18 and sliding the chain 18 along the slit 136 until it has been fed into the segment 122. The tubular member 130 can also include a ridge 134 that is generally a T-shaped flanged portion, and sized such that its waist (i.e. narrowed portion) fits along and within the edges defining the slit 136 as shown in FIG. 7, in order to join a pair of single segments 130 to each other as shown in FIG. 6 to effectively create a double segment 222. Advantages of the single segments 130 include the flexibility to create single or double implementations using the same part, and a lighter-weight component being required to be lifted in order to access the chain 18 to operate the window treatment 10.

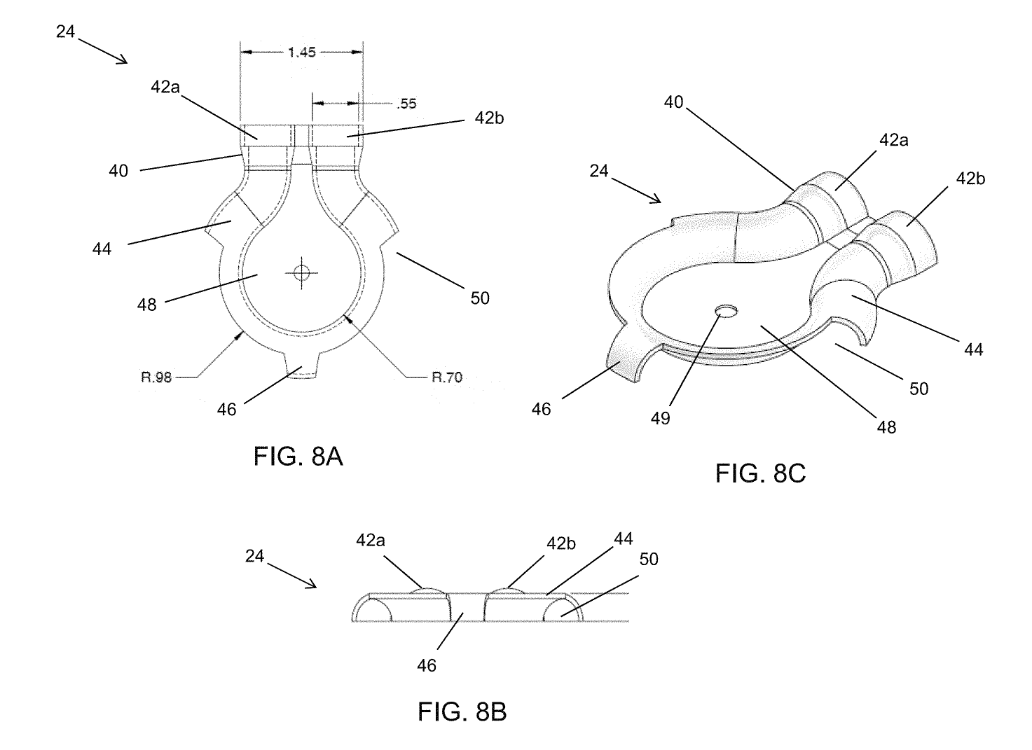

FIGS. 8A-8C illustrates one portion of the chain diverter 24, which is circular in shape in order to guide the chain 18 around a widened loop towards the bottom end of the cover 20 as one vertical run of the chain 18 changes direction into the other vertical run of the chain 18. The widening of the chain loop accommodates the passage and travel of chain connectors that are often used to connect the ends of a length of chain 18 to create a loop. Typically these chain connectors are rigid and bulkier than the chain beads, and thus could otherwise have difficulty making a tight return loop. As with FIG. 3, some example dimensions are shown in FIG. 8A for illustrative purposes only. The diverter 24 includes a connecting portion 40 having first and second flanges 42a, 42b, each sized to allow insertion of one of the tubular members 30 of the lowermost chain guide segment 22, when a pair of diverters 24a, 24b are snapped together (see also FIG. 11). The diverters 24 also include a housing 44 to cover, contain, and conceal at least a portion of the chain 18 and to prevent the chain 18 from becoming a choking hazard. The housing 44 is generally tubular in shape as best seen in FIG. 8C, and surrounds a central base 48 that is provided for rigidity. The housing 44 includes a pair of cutouts 50 that visually reveal a portion of the chain 18, the cutouts 50 being on either side of a curved tab 46 that is contoured to be aesthetically consistent with the other portions of the housing 44. The cutouts 50 are used to avoid chain connectors and/or stop beads from getting stuck or tangled within the chain diverter 24, particularly if a segment 22 of the cover 20 is being pushed up in order to operate the chain 18. The tab 46 also inhibits the chain 18 from falling out of the housing 44 if the chain diverter 24 is lifted, which could otherwise impede the normal rolling of the chain 18. The diverter 24 also includes a central hole 49 in the base 48, which allows for an installer to insert a securing screw 52 (see also FIG. 11A) that can be fastened to a vertical mullion of a window to prevent unwanted dangling motion of the chain 18 and cover 20. It can be appreciated that by using transparent plastics for the cover 20, the cover 20 can substantially blend into the window frame while at the same time revealing the color and style of the chain 18.

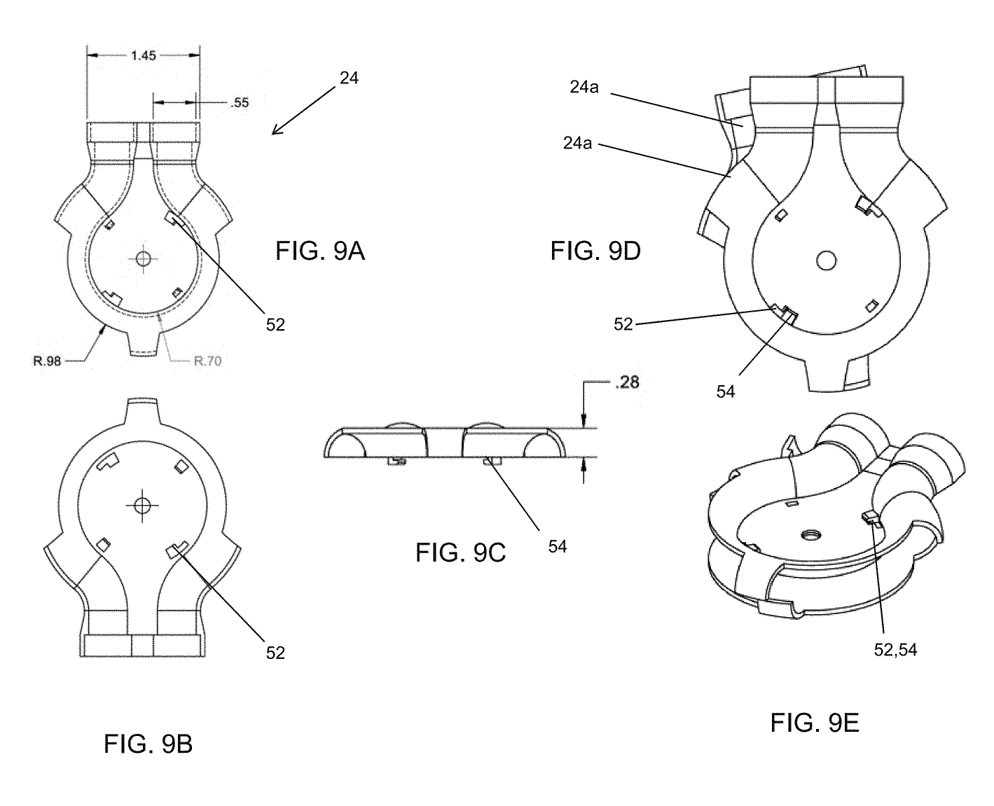

FIGS. 9A-9E illustrate an example of an implementation for enabling a pair of chain diverter portions 24a, 24b to be coupled to each other. As shown in FIG. 9A, the central base 48 can be provided with a pair of slots 52 that interact with a pair of teeth 54 on the underside of the other portion 24a/24b. The teeth 54 may then be inserted into the slots 52 and when the portions 24a/24b are rotated relative to each other as shown in FIG. 9D, the portions 24a/24b are locked together as shown in FIG. 9E. It can be appreciated that inserting the tubular members 22, 122 into the chain diverter portions 24a/24b after they are coupled together prevents counter rotation and disassembly of the unit.

FIGS. 11A and 1B illustrate assembled views of the cover 20 in one example having a pair of segments 22 and a chain diverter 24. It can be seen in FIGS. 11A and 11B that the diverter 24 is preferably composed of a pair of diverter portions 24a, 24b that snap or otherwise couple to each other (e.g., as shown in FIG. 9) to permit retrofitting of the diverter 24 to an existing chain 18. The lower segment 22 is connected to the chain diverter 24, and the upper segment 22 is free to slide along the chain 18 as illustrated in FIG. 11B. In this way, the exposed portion of the chain 18 that is normally above the cover 20 and below a clutch 60 for the lifting/lowering mechanism 16 permits another portion of the chain 18 to be exposed to manually operate the chain 18, by separating adjacent segments 22. In this example, the upper segment 22 is lifted along the chain 18 and slides towards the clutch 60 in order to expose a portion of the chain 18 that is further down the chain 18. To avoid the exposed portion of the chain 18 from twisting and/or bunching, a chain diverter 24 can also be installed at the upper end of the cover 20 and moving with the uppermost segment 22 as shown in FIG. 11C. The top chain diverter 24 also widens the separation between the vertical runs of the chain 18 near the clutch 60.

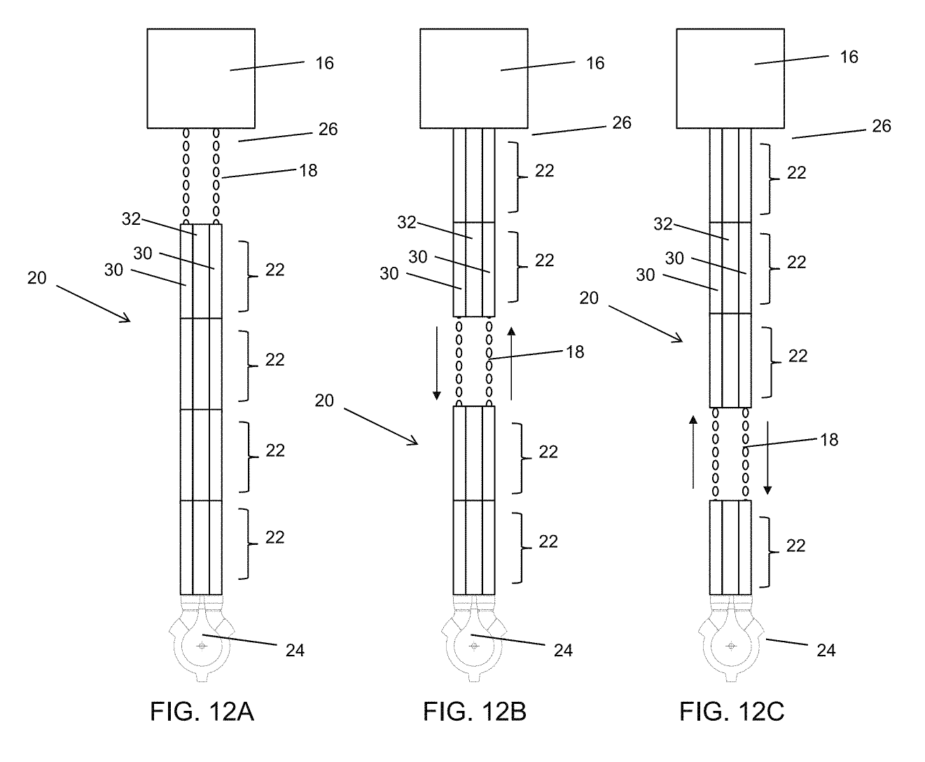

The segments 22 are stackable in various quantities, in order to accommodate different sizes of chains 18. For example, FIGS. 12A, 12B, and 12C illustrate a cover 20 that includes four segments 22 stacked along the chain 18, which are separable from each other to expose different portions of the chain 18, to allow for a user to manually operate the chain 18 at different levels. FIG. 12A shows the cover 20 in a rest position, wherein the segments 22 stack atop each other to effectively conceal a substantial portion of the chain 18 except for the exposed portion near the lifting/lowering mechanism 16. As indicated above, the exposed portion of the chain 18 allows adjacent segments 22 to be separated as shown in FIG. 12B at a desired spot along the vertical run of the chain 18. This allows a user to selectively access the chain 18 to pull either run of the chain in a desired direction in order to raise or lower the panel 12. As illustrated in FIG. 12C, by having several segments 22, different areas along the chain 18 can be targeted for separating adjacent segments 22. This allows users of different heights to access different portions of the chain 18 as desired. It can be appreciated, however, that the number and length of each segment 22 will vary based on the overall length of the chain 18 and thus the size of the window treatment. For example, it has been found that 6″ segments 22 are particularly suitable when a single length is to be used, but preferably different sized segments 22 are available, e.g., 6″, 12″, and 24″ in length. Since the length of the chain 18 can vary, and having differently sized segments 22 available, the exposed portion at the upper end will vary. It has been found that the space between the clutch 60 and the uppermost segment 22 is ideally 8″-12″ to allow convenient access to and operation of the chain 18. It can also be appreciated that the amount of chain 18 that is potentially exposed can be modulated to suit regulations or restrictions in various jurisdictions. As such, having multiple different lengths for the segments 22 facilitates the flexibility to accommodate these various circumstances.

As noted above, to operate the roller shade 10, the segments 22 are separated to access the chain to manually operate the shade 10 in the normal fashion. The amount of chain 18 that is exposed is dictated, and thus limited by, the amount of exposed portion at the top. For example, as noted above, leaving 8″-12″ between the clutch 60 and the uppermost segment 22 (or upper chain diverter 24) when at rest has been found to provide a suitable amount of chain 18 to operate a roller shade 10. It can be appreciated that the light-weight plastic construction enables a user to lift the segments 22 and operate the chain 18 using one hand.

While providing less rigidity to the cover 20, as indicated above the tubular members 130 can also be used separately and without a connecting portion 32, as shown in FIG. 13A. However, in some cases, to avoid the ability to create a loop that can cause the aforementioned choking hazards, a relatively longer segment 22 should be used in such scenarios, e.g., about 12″ or more. In this way, the segments 22 are inhibited from wrapping around the neck of a user. In another implementation, shown in FIG. 13B, a mix of double segments 22 and individual tubular members 130 can also be provided in constructing the cover 20, but with the above considerations in mind regarding the length of segments 122 being used. As such, various configurations are possible. As shown in FIG. 13C, this can include the provision of connecting portions 132 that are less than the length of the tubular members 30, to reduce the amount of material used or to change the look and feel from the side view, without reducing the overall rigidity of the segments 222.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. A cover for a chain or cord used to manually operate a window treatment, the cover comprising at least one pair of rigid tubular members to permit passage of the chain or cord therethrough during operation of the window treatment.

2. The cover of claim 1, further comprising a connecting portion between at least one pair of tubular members.

3. The cover of claim 1, further comprising a slit along the length of each of the tubular members to permit the chain or cord to be inserted thereinto.

4. The cover of claim 3, wherein the slits are aligned to position the slits on one side of the cover.

5. The cover of claim 1, wherein the tubular members are made from a clear plastic.

6. The cover of claim 1, wherein the tubular members are from about six inches to about twenty four inches in length.

7. The cover of claim 1, wherein a first of the tubular members comprises a slit along its length, and a second of the tubular members comprises a flanged portion extending from an outer surface of the second of the tubular members, the flanged portion comprising a narrowed portion sized to permit the flanged portion to slide along the slit of the first of the tubular members to connect the first and second tubular members to each other.

8. A cover for a chain or cord used to manually operate a window treatment, the cover comprising a plurality of chain guide segments, each segment comprising a pair of rigid tubular members to permit passage of the chain or cord therethrough during operation of the window treatment, wherein a total length of the plurality of segments is less than each vertical run of the chain or cord to permit separation of adjacent ones of the segments to expose a portion of the chain or cord to manually operate the window treatment.

9. The cover of claim 8, further comprising a connecting portion between at least one pair of tubular members.

10. The cover of claim 8, further comprising a slit along the length of each of the tubular members to permit the chain or cord to be inserted thereinto.

11. The cover of claim 10, wherein the slits are aligned to position the slits on one side of the cover.

12. The cover of claim 8, wherein the tubular members are made from a clear plastic.

13. The cover of claim 8, wherein each segment is from about six inches to about twenty four inches in length.

14. The cover of claim 8, further comprising a circular chain separator for widening a distance between vertical runs of the chain or cord.

15. The cover of claim 14, wherein the chain separator is for concealing a bottom loop of the chain or cord, and coupled to a lowermost one of the plurality of segments; or is for separating the chain or cord near a clutch in the window treatment and coupled to an uppermost one of the plurality of segments.

16. The cover of claim 14, wherein the chain separator is sized such that the bottom loop of the chain is wider than a distance between the vertical runs of the chain or cord.

17. The cover of claim 14, comprising a pair of chain separator portions that are configured to be coupled to each other to conceal the bottom loop of the chain or cord.

18. The cover of claim 14, further comprising at least one cutout in a housing of the chain separator to expose a portion of the chain in the bottom loop.

19. A window treatment comprising:
a panel for covering at least a portion of a window;
a lifting/lowering mechanism connected to the panel;
a chain or cord for manually operating the lifting/lowering mechanism; and
a cover for the chain or cord, the cover comprising a plurality of chain guide segments, each segment comprising a pair of rigid tubular members to permit passage of the chain or cord therethrough during operation of the window treatment, wherein a total length of the plurality of segments is less than each vertical run of the chain or cord to permit separation of adjacent ones of the segments to expose a portion of the chain or cord to manually operate the window treatment.

20. The window treatment of claim 19, further comprising a connecting portion between at least one pair of tubular members.

21. The window treatment of claim 19, further comprising a circular chain separator for widening a distance between vertical runs of the chain or cord.

22. The window treatment of claim 21, wherein the chain separator is for concealing a bottom loop of the chain or cord, and coupled to a lowermost one of the plurality of segments; or is for separating the chain or cord near a clutch in the window treatment and coupled to an uppermost one of the plurality of segments.

23. The window treatment of claim 21, comprising a pair of chain separator portions that are configured to be coupled to each other to conceal the bottom loop of the chain or cord.

24. The window treatment of claim 19, further comprising a slit along the length of each of the tubular members to permit the chain or cord to be inserted thereinto.
